(19) United States
(12) Patent Application Publication
(10) Pub. No.: US 2003/0198857 A1
(43) Pub. Date: Oct. 23, 2003

(54) Graphite laminate fuel cell plate

(76) Inventors: Edward C. McManus, Livonia, NY (US); David P. Lyons, Pittsford, NY (US)

Correspondence Address: THOMAS B. RYAN, EUGENE STEPHENS & ASSOCIATES, 56 WINDSOR STREET, ROCHESTER, NY, 14605, US

(21) Appl. No.: 10/405,173

(22) Filed: Apr. 2, 2003

Related U.S. Application Data
(60) Provisional application No. 60/370,165, filed on Apr. 5, 2002.

(51) Int. Cl. H01M 8/02; H01M 8/10; B29C 43/00

(52) U.S. Cl. 429/38; 429/30; 429/35; 264/320

(57) ABSTRACT

A laminated fuel cell plate has a sheet metal layer compression molded between two layers of expanded graphite. The sheet metal layer provides resilient support for making thinner plates. The sheet metal layer also functions as a permeability barrier, which allows the conductivity of the expanded graphite layers to be enhanced. Features are molded into the graphite layers for such purposes as alignment, sealing, and flow control.

This application claims the benefit of U.S. Provisional Application No. 60/370,165, filed on Apr. 5, 2002, which provisional application is incorporated by reference herein.

### TECHNICAL FIELD

The invention relates to electrochemical fuel cell plates made by densifying graphite and is particularly concerned with compression molding of graphite into a laminated structure.

### BACKGROUND

Fuel cell plates perform a variety of functions in electrochemical fuel cells, such as serving as current collectors, series connections between adjacent fuel cells, structural supports, fluid flow distributors, permeability barriers, and conduits for conveying fuel and oxidant reactants and water-reaction products. The plates must also be physically and chemically compatible with the operating environment, which includes a tolerance for elevated temperatures and acidity in the presence of reactant fluids. Since fuel cells often contain large numbers (e.g., 100 or more) of the plates, the plates should also be thin, lightweight, and inexpensive.

Some such plates, referred to as bipolar plates, support reactions within adjacent cells. One side of a bipolar plate supports anode reactions of one cell, and the other side supports cathode reactions of an adjacent cell. Both sides are conductive and support a series of electrical connection between them. However, bipolar plates are also required to provide a permeability barrier between adjacent cells to prevent electrolytic exchanges.

Metals such as titanium have been fashioned as fuel cell plates, particularly where cost is not a concern. The metal plates are cut or etched to contain features required for managing fluid flows. In addition to material costs, the etching required to form flow channels for the reactants adds considerable manufacturing cost and is time consuming.

Injection molding is regarded as a way of reducing manufacturing costs for high volume production of fuel cell plates. However, materials with the requisite qualities including high conductivity are generally not sufficiently flowable for injection molding operations.

Compression-molded thermoplastic plates filled with graphite or other carbon compounds have also been successfully manufactured as fuel cell plates. The thermoplastic resin provides a permeability barrier, and the carbon filler provides conductivity. However, to achieve requirements for structural support, the compression-molded plates tend to be relatively thick and heavy.

Among the compression-molded plates are plates made from sheets of expanded graphite impregnated with thermoplastic resin. The expanded graphite is rolled into a sheet, impregnated with resin, and stamped or otherwise compression molded to form the required surface features. The steps required for impregnating and curing the resin add cost, and the resulting expanded graphite plates are still relatively thick and heavy.

### SUMMARY OF INVENTION

Our fuel cell plate in one or more of its preferred embodiments is formed as a laminate of two layers of expanded graphite material molded about an intermediate layer of sheet metal. The expanded graphite is preferably molded to form channels, seals, or locating features in opposite surfaces of the laminated fuel cell plate. The sheet metal layer forms a permeability barrier and provides additional structural support for reducing the overall thickness of the plate. In addition, conductivity of the expanded graphite layers can be optimized by relying on the sheet metal layer to provide structural support and a permeability barrier.

The surface features of the laminated plate are preferably formed by compression molding. In preparation for the compression molding operation, the expanded graphite can be arranged in sheet form and stacked together with the intermediate sheet metal layer, or the expanded graphite can be arranged in a particulate form within a compression mold containing the sheet metal layer. Channels, seals, and locating features are preferably formed by the compression molding operation in the expanded graphite layers. Thicknesses and densities of the molded graphite layers can be varied to enhance the performance of the seals and other features.

The features that project at the greatest height are also the features that are least compressed, which advantageously supports the locating and sealing functions. When mounted under compression within a fuel cell, the more pliant features better adapt to sealing conditions by accommodating inevitable variations. Additional sealing capability, particularly for sealing flow channels, can be achieved by reducing the width of the projecting sealing features. For example, narrow lands can be fashioned atop the walled structures that form intra-plate flow channels.

The sheet metal layer provides a permeability barrier between the expanded graphite layers and can function as resilient support for the expanded graphite layers. Both functions performed by the sheet metal layer relieve requirements for the expanded graphite layers so that the expanded graphite layers can be optimized for other purposes such as conductivity. The sheet metal layer is preferably made of stainless steel or other corrosion-resistant metals, such as titanium, titanium alloys, and metal nitrides, to promote conductivity and to avoid adverse reactions with fuel cell fluids. However, to the extent that the expanded graphite layers effectively encapsulate the sheet metal layer, a variety of other conductive structural materials can also be considered for the intermediate layer. Sheet metal edges surrounding openings through the laminated fuel cell plate can be encapsulated by expanded graphite-to-expanded graphite bonds lining the openings. Similar encapsulation techniques can be applied to the outer edge of the laminated fuel cell plate to provide a stronger bond joining the graphite and metal layers.

Silicone or other sealants or insulators, such as TEFLON® (polytetrafluoroethylene) and fiberglass, can be applied (e.g., sprayed, coated, or injection molded) to the outer edge of the laminated fuel cell plate or to one or both faces of the laminated plate to electrically isolate the individual laminated plates from their immediate surroundings or to confine fluids within, without, or between the laminated plates. Similar seals can also be incorporated into locating features between the laminated fuel cell plates to confine the movement of fluids across the surfaces of individual fuel cell plates or to confine the movement of fluids along inter-plate conduits.

Our new laminated fuel cell plate is intended for manufacture at reduced thicknesses and, in some instances, at thicknesses less than a sum of the required channel depths on opposite sides of the laminated plate. As such, the channels on one side of the laminated plate are aligned with the walled structures that confine the channels on the other side of the laminated plate, and the sheet metal layer is deformed to follow the resulting contour. Although the bottoms of the channels and other features formed by compression molding are preferably compacted as much as possible to the sheet metal layer for reducing overall thickness, the increased density of the highly compressed bottoms reduces exposure of the sheet metal layer to the corrosive environment of the fuel cell.

### DRAWINGS

FIG. 1 is a plan view of our laminated fuel cell plate with fluid flow channels across the surface of the plate abbreviated for simplicity.

FIG. 2 is an exploded isometric view depicting three inter-molded layers of the laminated plate.

FIG. 3 is an enlarged cross-sectional view taken along line 3-3 of FIG. 1 showing the encapsulation of an intermediate layer between two inter-plate conduits.

FIG. 4 is a similarly enlarged cross-sectional view taken along line 4-4 of FIG. 1 showing the encapsulation of the intermediate layer along an outer edge of the laminated plate.

FIG. 5 is a broken-away cross-sectional view separately showing a pair of bipolar plates and a fuel cell membrane.

FIG. 6 is a similar cross-sectional view showing an assembly of the bipolar plates and the fuel cell membrane in operative positions.

FIG. 7 is a broken-away cross-sectional view of mating surfaces of locating features with silicone attached as a seal and electrical insulator.

FIG. 8 is broken-away cross-sectional view of a two-jaw mold containing an alternative bipolar plate in which compression within the mold is shown to produce local distortions of an intermediate layer for reducing thickness.

FIG. 9 is a cross-sectional view showing a portion of a single-pole plate.

### DETAILED DESCRIPTION

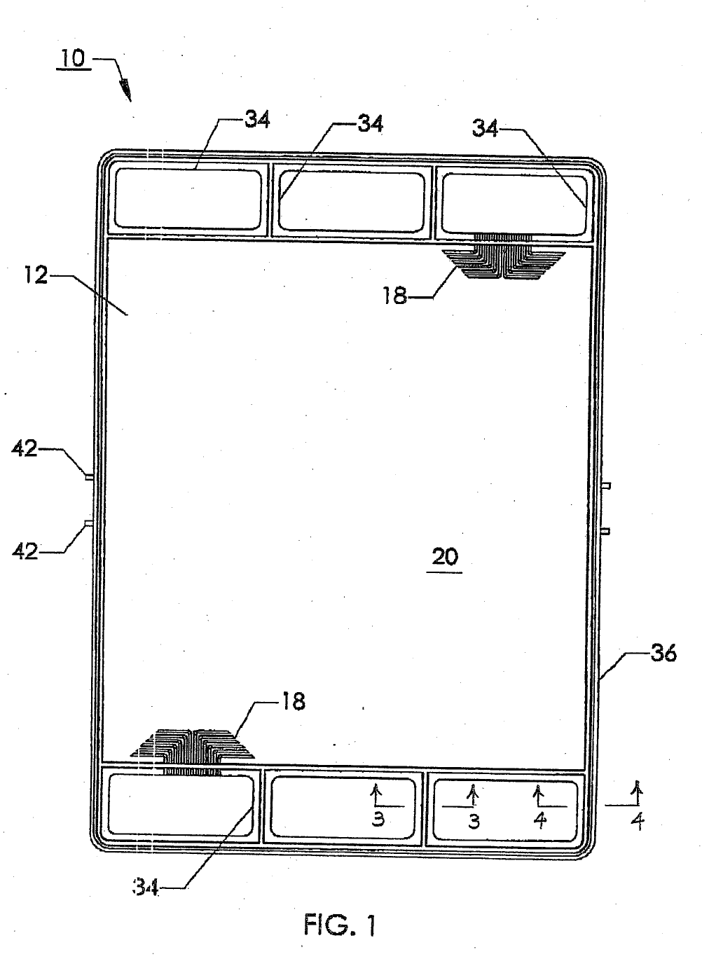

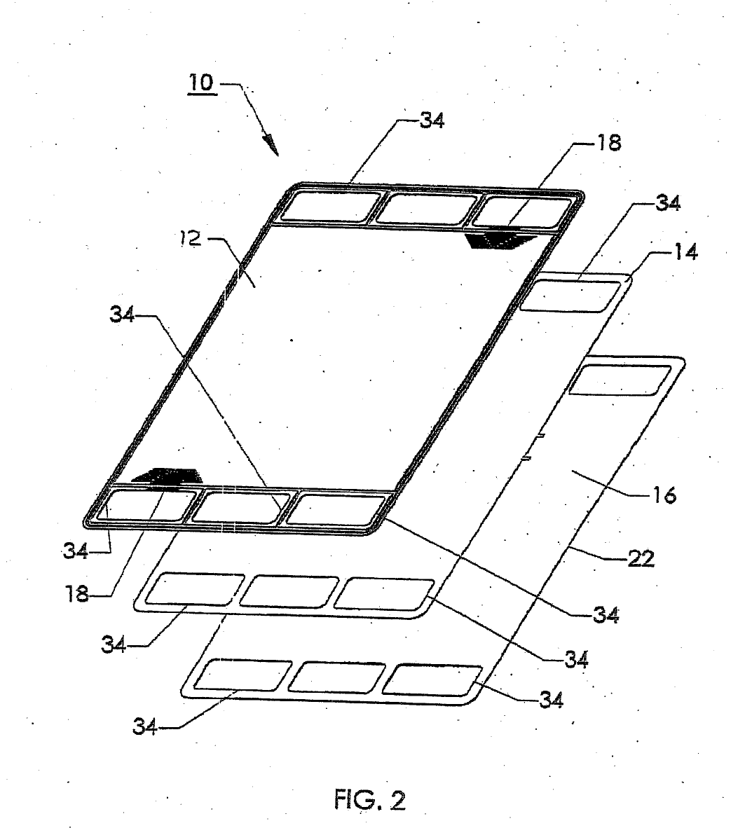

An exemplary laminated bipolar fuel cell plate 10 variously illustrated by FIGS. 1 and 2 is composed of two layers 12 and 16 of an expanded graphite material and an intermediate layer 14 of sheet metal. The two expanded graphite layers 12 and 16 are compression molded together about the sheet metal layer 14, creating a single laminated body.

The expanded graphite, which is also referred to as an exfoliated graphite, can be formed by treating natural graphite flakes with an agent that intercalates into the crystal structure to expand the intercalated particles. The material is available in flake or calendered sheet form from a number of sources including UCAR Carbon Technology Corporation of Cleveland, Ohio. In this embodiment, the final thickness of the expanded graphite layers 12 and 16 is preferably only a little more than the required depths of fluid flow channels 18 formed in a front surface 20 and a back surface 22 of the laminated bipolar plate 10. For example, at channel depths of around 0.020 inches (0.5 millimeters), the compression-molded expanded graphite layers 12 and 16 are expected to be around 0.024 inches to 0.028 inches (0.6 to 0.7 millimeters).

The sheet metal layer 14 is preferably made of a corrosion-resistant conductive metal, such as stainless steel, titanium, titanium alloys, or metal nitrides (e.g., CR—N, Nb—N, Ti—N, and V—N), having flexible structural properties for reinforcing the two expanded graphite layers 12 and 16. The non-corrosive form of the sheet metal layer 14 withstands exposure to the harsh chemical environment of fuel cells. The conductive form of the sheet metal layer 14 supports electrical (e.g., series) connections between adjacent fuel cell plates. The resiliency of the sheet metal layer 14 improves fracture toughness and retains the flat overall shape of the laminated bipolar plate 10 at a minimum overall thickness. For example, the sheet metal layer 14 can be formed at a thickness-of around 0.007 inches (less than 0.2 millimeters) so that a combined thickness of the laminated bipolar plate 10 with 0.020 inch channels can be as small as 0.055 inches (1.4 millimeters). However, the sheet metal layer 14 can be formed at a wide range of thicknesses, such as between 0.001 inches (0.025 millimeters) and 0.010 inches (0.254 millimeters), depending upon the structural requirements for the layer.

In an appropriately corrosion-resistant yet conductive form, the sheet metal layer 14 also provides a permeability barrier between the opposite surfaces 20 and 22 of the laminated bipolar plate 10. The permeability barrier of the sheet metal layer 14 prevents the exchange of electrolytic or other reaction/by-product materials between adjacent fuel cells. The impermeability function requires the sheet metal layer 14 to have an uninterrupted form with no unsealed gaps through which reactants/by-products can flow between operative regions of the adjacent cells. To the extent that the sheet metal layer 14 is relied on to provide a permeability barrier, the expanded graphite layers 12 and 16 can be optimized for conductivity. For example, the separate permeability function of the sheet metal layer 14 can obviate the need to impregnate or coat the graphite with resin or other materials that diminish conductivity. Other conductive structural sheet metal materials having greater or lesser corrosion-resistant properties can be used, depending upon the effective encapsulation of the sheet metal layer 14 between the two expanded graphite layers 12 and 16.

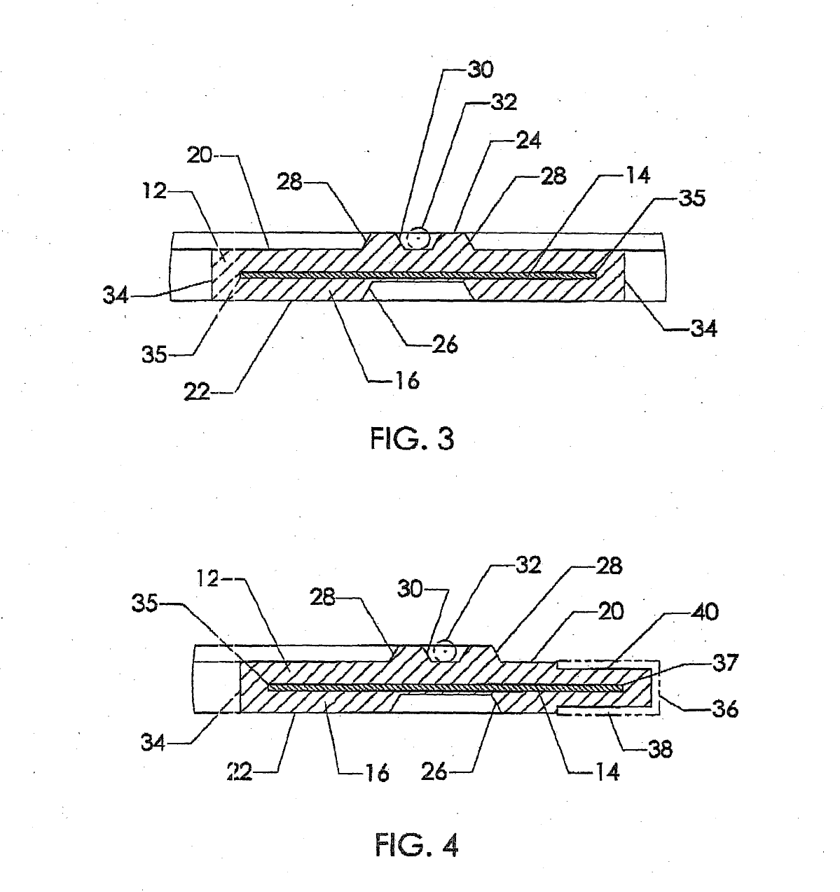

FIGS. 3 and 4 show details of the encapsulation and other features that can be formed in the expanded graphite layers 12 and 16. In both FIG. 3, which shows a cross section between openings 34 through the laminated bipolar plate 10, and FIG. 4, which shows a similar cross section between one of the openings 34 and a periphery 36 of the laminated bipolar plate 10, the intermediate sheet metal layer 14 is entirely encapsulated between the expanded graphite layers 12 and 14. Corresponding openings 35 in the sheet metal layer 14 are preferably preformed by die cutting or other conventional means at sizes slightly larger than the molded openings 34 formed by the two expanded graphite layers 12 and 16 so that the two graphite layers 12 and 16 line the openings 34. Similarly, an outer periphery 37 of the sheet metal layer 14 is formed entirely within the periphery 36 formed by the two expanded graphite layers 12 and 16 to further join the two expanded graphite layers 12 and 16 independently of the sheet metal layer 14. The resulting integral bond between the two graphite layers 12 and 16 limits exposure of the edges of the sheet metal layer 14 to the corrosive environment of fuel cells and prevents delaminating.

From a manufacturing perspective, the openings 34 in the expanded graphite layers 12 and 16 and the corresponding openings 35 in the sheet metal layer 14 could be formed together by die cutting. Although die cutting the three layers 12, 14, and 16 together would leave exposed edges (not shown) of the metal layer 14, the die cutting operation itself could be carried out efficiently because the two graphite layers 12 and 16 would function as lubricants. If necessary, the exposed edges of the sheet metal layer 14 could be coated or lined with a protective layer such as silicone, TEFLON® (polytetrafluoroethylene), or fiberglass.

The features molded into the expanded graphite layers 12 and 16 include interlocking male and female locating features 24 and 26, which are formed in the front and back surfaces 20 and 22 of the laminated bipolar plate 10 during the compression molding operation. The two locating features 24 and 26 can be used to align and seal adjacent plates or to capture other components within fuel cells. The locating features 24 and 26 extend adjacent to the periphery 36 of the laminated bipolar plate 10 and surround the openings 34 through the laminated plate 10. The male locating feature 24 is formed by a pair of parallel protrusions 28 that straddle a trough 30 for containing a seal 32. The densities and thicknesses of the male and female locating features 24 and 26 can be varied to enhance their sealing and locating functions. For example, a reduced density of the male features 24 can enhance their sealing function by providing enlarged areas of contact with the female features 26.

The seal 32 can be laid down along the trough 30 in a variety of ways including by extruding, coating, or injection molding a sealant/insulating material such as silicone, TEFLON® (polytetrafluoroethylene), or fiberglass. Another seal/insulator 38 is shown in a U-shaped configuration encapsulating the plate periphery 36. The seal/insulator 38, which can be laid down similar to the seal 32, is received in recesses 40 for limiting the stacking thickness of the laminated plate 10. Similar seal/insulators can be laid down on just the front surface 20, the back surface 22, or the periphery 36.

The sheet metal plate 14 can be cut out, punched, stamped, die cut, or otherwise operated upon to produce features in addition to the openings 35. For example, FIG. 1 shows electrical pin contacts 42 that project from edges of the sheet metal plate 14 through the periphery 36 of the laminated bipolar plate 10. The removal or shaping of the sheet metal plate 14 can be further coordinated with the over-molding of the expanded graphite layers to form other features for managing electrical or fluid flows or for performing sealing, locating, or assembly functions.

For performing the required compression molding operation, the expanded graphite can be loaded within a compression mold in particle form together with the sheet metal layer 14 or in a partly compressed calendered sheet form in a stack with the sheet metal layer 14. Both sides 20 and 22 of the laminated bipolar plate 10 are preferably molded together so that the expanded graphite lining the openings 34 and the periphery 36 forms a strong bond joining the expanded graphite layers 12 and 16 together. However, the opposite sides 20 and 22 of the laminated plate 10 could be separately molded, such as by using a shuttle mold during the second molding operation.

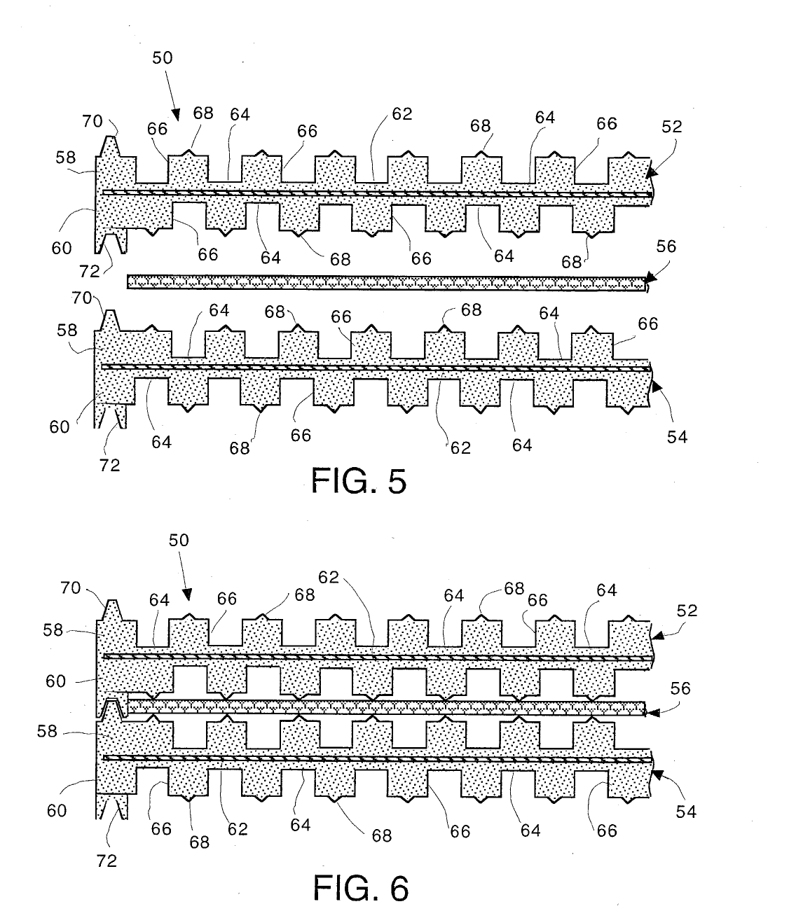

FIGS. 5 and 6 show local components of a fuel cell 50 formed by two pairs of laminated bipolar plates 52 and 54 straddling a fuel cell membrane 56. Each of the bipolar plates 52 and 54 includes an anode current collector 58 and a cathode current collector 60 formed by compression-molded graphite and an intermediate separator layer 62 made from a layer of sheet metal. Flow channels 64 are compression molded within the current collectors 58 and 60 between walled structures 66 that are somewhat less compressed.

On the tops of the walled structures 66 are narrow lands 68 that provide for gripping and sealing with opposite sides of the fuel cell membrane 56. The narrow lands 68 are less compressed than the surrounding walled structures 66 and provide a measure of compliance for enhancing a sealing function and better confining gasses transported along the flow channels 64.

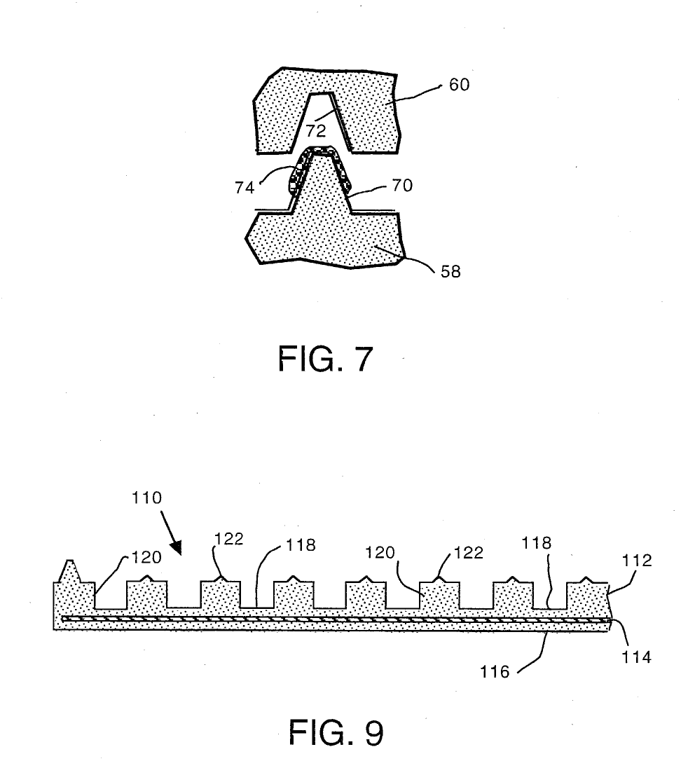

An additional sealing function is performed by male and female locating features 70 and 72. The male feature 70 as shown in FIG. 7 has a coating of silicone 74 to enhance sealing, while providing electrical insulation between the adjacent bipolar plates 52 and 54. The silicone coating 74 is preferably sprayed on the male feature 70, but could also be applied by other means including extrusion to the male feature 70, the female feature 72, or both. Alternative coating materials include TEFLON® (polytetrafluoroethylene) and fiberglass.

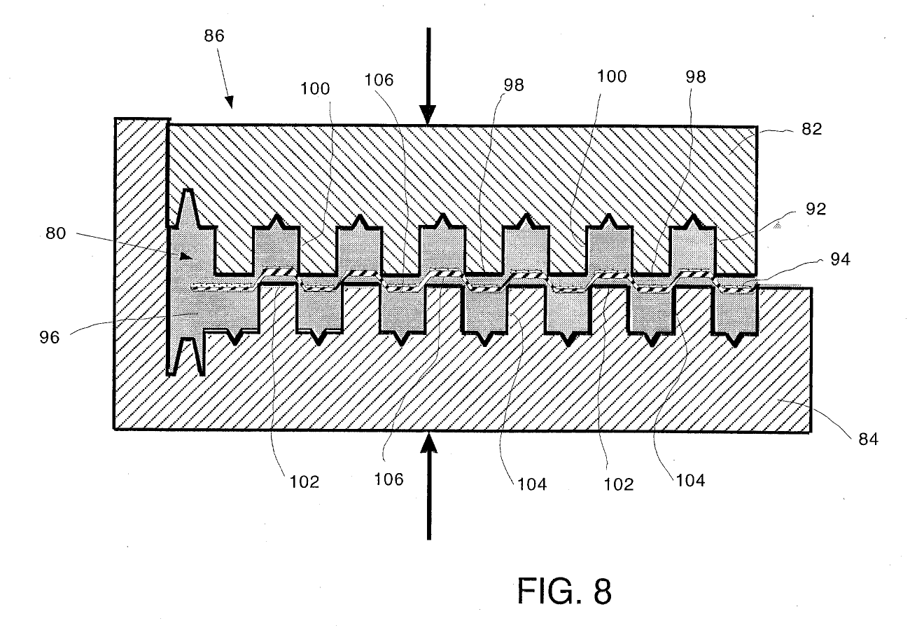

An alternative bipolar plate 80 is shown in FIG. 8 between two jaws 82 and 84 of a compression mold 86. Within the mold 86, the bipolar plate 80 is fashioned from a sheet metal layer 94 and two graphite layers 92 and 96 that are compacted from expanded graphite through both sides of the sheet metal layer 94.

Channels 98 in the graphite layer 92 are aligned with walled structures 104 of the graphite layer 96, and channels 102 of the graphite layer 96 are aligned with walled structures 100 of the graphite layer 92. The walled structures 100 and 104 are slightly wider than the channels 98 and 102 so that the channels 98 and 102 can be compressed toward or within the walled structures 100 and 104 to reduce the overall thickness of the bipolar plate 80. This compression pattern locally deforms the sheet metal layer 94 to accommodate the space savings.

The local deformations 106 of the sheet metal layer 94 follow bottom contours of the channels 98 and 102 as they alternately impinge on the original plane of the sheet metal layer 94. However, the local deformations 106 do not disturb the intended functions of the sheet metal layer 94 including its functions as a permeability barrier, as a conductive pathway between cells, and as a flexible support. In fact, the local deformations 106 transform the sheet metal layer 94 into a corrugated form that is expected to support a stronger bond with the graphite layers 92 and 94.

Our preferred embodiments fashion our new fuel cell plate as a bipolar plate as shown in the preceding drawing figures, but a similar laminated structure can also be fashioned in accordance with our invention into a single-pole plate 110 as shown in FIG. 9. Such a single-pole plate 110 is capable of supporting electrochemical reactions at one side of a fuel cell while preventing unwanted reactant/by-product exchanges with adjacent cells.

Similar to the preceding embodiments, the single-pole plate 110 is fashioned from two layers of graphite 112 and 116 straddling a sheet metal layer 114. Compression molded within the graphite layer 112 are an arrangement of fluid flow channels 118 formed between remaining walled structures 120. Also molded within the graphite layer 112 are graphite seals 122 atop the walled structures 120 and a mating locating feature 124 for joining the single-pole plate 110 to another single-pole plate of the same fuel cell. Although not shown, various locating and sealing features could also be formed in the graphite layer 116 for connecting the single-pole plate 110 to an adjoining fuel cell.

The graphite layers 112 and 116 function together with the sheet metal layer 114 as a current collector, and the graphite layer 116 provides a basis for making a series-type electrical connection with an adjoining fuel cell. The sheet metal layer 114 also functions similar to its role in our bipolar plates by improving fracture toughness of the single-pole plate 110 and by providing a permeability barrier to prevent the egress/ingress of unwanted chemical reactants and byproducts.

Although our laminated fuel cell plates are preferably constructed with two layers of expanded graphite and one layer of sheet metal, an alternative separator plate could be constructed with just one layer of expanded graphite and one layer of sheet metal. In the alternative design, the edges of the sheet metal are still preferably overlapped by the molded expanded graphite to provide more certain bonding between the two layers. Where possible, it is preferred to design the features of the fuel cell plates with symmetry to allow the plates to be invertable to compensate for odd order errors in thickness.

We claim:

1. A laminated graphite plate for an electrochemical fuel cell comprising:
two layers of a graphite material being compression molded together with an intermediate layer of sheet metal;
flow-directing features being compression molded into at least one of the layers of graphite to direct flows of reactants across the plate; and
the intermediate layer of sheet metal being laminated between the two layers of graphite material to provide a structural support and a permeability barrier for preventing unwanted flows of the reactants between the graphite layers.

2. The plate of claim 1 in which the sheet metal layer is made of an electrically conductive metal.

3. The plate of claim 2 in which the electrically conductive metal exhibits corrosion resistance to the reactants that are prevented from flowing between the graphite layers.

4. The plate of claim 3 in which the sheet metal layer is made from a material selected from a group of corrosion-resistant electrically conductive metals consisting of stainless steel, titanium, titanium alloys, and metal nitrides.

5. The plate of claim 1 in which the layers of graphite material are compression molded from an expanded graphite material.

6. The plate of claim 5 in which the expanded graphite material is free of extraneous polymer materials that diminish conductivity of the compressed graphite layers.

7. The plate of claim 1 further comprising a locating feature being compression molded into at least one of the layers of graphite to align the plate with an adjacent plate within a fuel cell.

8. The plate of claim 7 in which the locating feature includes one of a male and female locating features.

9. The plate of claim 8 in which the locating features are molded at a reduced density.

10. The plate of claim 7 in which a sealant is applied to the locating feature to enhance sealing with the adjacent plate.

11. The plate of claim 10 in which the sealant is an electrical insulator to inhibit conduction between adjacent plates.

12. The plate of claim 1 in which the flow-directing features include walled structures separating channels, and lands are molded atop the walled structures to provide improved sealing with other components of the fuel cell.

13. The plate of claim 1 in which:
at least one opening is formed through the two graphite layers and the sheet metal layer to function as a conduit through the fuel cell, and
the two layers of expanded graphite are contiguous within the opening to avoid exposure of the sheet metal layer within the opening.

14. The plate of claim 13 in which locating features are compression molded into both of the graphite layers for forming male and female interlocks between adjacent plates of the fuel cell.

15. The plate of claim 1 in which the flow-directing features are compression molded into both of the graphite layers.

16. The plate of claim 15 in which the sheet metal layer is deformed to follow contours of the flow-directing features formed in both graphite layers.

17. The plate of claim 15 in which the flow-directing features include walled structures separating channels, and the channels formed in one of the graphite layers are aligned with the walled structures of the other of the graphite layers so that the channels can be compressed toward the walled structures to reduce a thickness of the plate.

18. The plate of claim 17 in which the sheet metal layer is locally deformed between alternating channels formed in opposite sides of the graphite layers.

19. An electrochemical fuel cell assembly comprising:
first and second fuel cell plates straddling a fuel cell membrane;
each of the first and second fuel cell plates being formed by a sheet metal layer compression molded between two graphite layers; and
locating features being compression molded within adjacent graphite layers of the fuel cell plates for aligning the first and second fuel cell plates with respect to each other.

20. The fuel cell assembly of claim 19 further comprising flow-directing features being compression molded within the adjacent graphite layers to direct flows of reactants across the plates.

21. The fuel cell assembly of claim 20 in which the flow-directing features include walled structures separating channels, and lands are compression molded atop the walled structures to provide improved sealing with the fuel cell membrane.

22. The fuel cell assembly of claim 19 in which the locating features include male and female locating features formed within the adjacent graphite layers.

23. The fuel cell assembly of claim 22 in which the locating features are molded at a reduced density to improve sealing capabilities.

24. The fuel cell assembly of claim 22 in which a sealant is applied to at least one of the locating features to enhance sealing between the first and second plates.

25. The fuel cell assembly of claim 24 in which the sealant is an electrical insulator to inhibit conduction between adjacent plates.

26. The fuel cell assembly of claim 19 including openings through the first and second fuel cell plates wherein:
(a) both of the openings are formed through the two graphite layers and the sheet metal layer of each plate to function as a through conduit, and
(b) the two layers of expanded graphite within each plate are contiguous within the openings to avoid exposure of the sheet metal layers within the openings.

27. The fuel cell assembly of claim 26 in which the locating features surround the openings to seal passageways between the plates.

28. The fuel cell assembly of claim 19 in which the fuel cell plates are bipolar plates and include locating features compression molded within the remote graphite layers for interlocking with bipolar plates of adjacent cells.

29. A method of making a laminated graphite fuel cell plate comprising steps of:
loading expanded graphite together with a sheet metal layer in the form of a stack within a compression mold;
compacting the expanded graphite on opposite sides of the sheet metal layer so that at least an outer edge of the sheet metal layer is encapsulated between layers of graphite and the two layers of graphite are bonded to each other around the outer edge of the sheet metal layer; and
molding flow-directing features into at least one of the layers of graphite for fluid flows across the plate.

30. The method of claim 29 including an additional step of preforming openings in the sheet metal layer, and wherein the step of compacting includes compacting the expanded graphite to line the openings in the sheet metal layer and to bond the two graphite layers to each other around the openings.

31. The method of claim 29 including an additional step of die cutting openings directly through both graphite layers and the sheet metal layer to provide a conduit through the plate.

32. The method of claim 29 including an additional step of molding a locating feature within at least one of the graphite layers.

33. The method of claim 32 including a further step of applying an electrically insulating sealant to the locating feature.

34. The method of claim 29 in which the step of molding flow-directing features includes molding channels separated by walled structures within the at least one graphite layers.

35. The method of claim 34 including an additional step of molding lands atop the walled structures for performing a sealing function.

36. The method of claim 34 in which the channels are molded into both graphite layers.

37. The method of claim 36 including an additional step of deforming the sheet metal layer to conform with the channels formed from opposite sides of the graphite layers.
